(19) United States
(12) Patent Application Publication
(10) Pub. No.: US 2010/0060113 A1
(43) Pub. Date: Mar. 11, 2010

(54) Hinged Door System for Attachment to a Display Unit

(75) Inventors: Bruno Dell'Unto, Toronto (CA); Stephen Myska, Toronto (CA); George Grady, Newmarket (CA); Philip Beder, Thornhill (CA); Davit Katz, Thornhill (CA)

Correspondence Address: THE WEBB LAW FIRM, P.C., 700 KOPPERS BUILDING, 436 SEVENTH AVENUE, PITTSBURGH, PA, 15219, US

(73) Assignee: 4 SOLUTIONS DISPLAY CORP., Toronto (CA)

(21) Appl. No.: 12/206,420

(22) Filed: Sep. 8, 2008

(51) Int. Cl. A47F 3/00; E05B 1/00

(52) U.S. Cl. 312/138.1; 16/412

(57) ABSTRACT

There is provided a magnetically held hinged door for a display unit. The magnetically held hinged door includes a top plastic extruded component having three parts; a flange portion having one or more magnets adapted to removably attach the hinged door to metal shelves and other metal parts of the display unit; a retaining portion comprising an inverted U-shaped channel and a plurality of gripping tabs disposed in the inverted U-shaped channel; and a flexible hinge interconnecting the flange portion and the retaining portion. The magnetically held hinged door also includes a panel having an upper end removably retained within the inverted U-shaped channel. The magnetically held hinged door swings about the flexible hinge between a first closed position and a second open position.

### FIELD OF THE INVENTION

The present invention relates to a hinged door system for attachment to a display unit, and more particularly to a modular hinged door system that may be removably attached to a display unit to hide the contents stored on the unit.

### BACKGROUND OF THE INVENTION

Traditionally, cigarettes and other tobacco products have been sold at the retail level by displaying the packages on store shelves and other display units. This type of marketing in the retail point-of-sale environment is one of the few remaining marketing opportunities available to the tobacco industry in many jurisdictions, especially Canada.

However, an increasing number of studies have determined that there is a link between the marketing of tobacco products and adolescent smoking initiation. In particular, many studies have recognized that retail point-of-sale marketing contributes to smoking initiation. As a result, jurisdictions around the world have been placing restrictions on what marketing is allowed for tobacco products.

Most recently, many jurisdictions in Canada, such as the provinces of Saskatchewan, Manitoba, Quebec and Ontario no Longer allow tobacco products to be displayed at retail point-of-sale. For example, the Smoke-Free Ontario Act that came into force in 2008 eliminated the use of countertop displays and “power walls” in retail stores. Power walls are rows of cigarette and other tobacco product packages stored in display shelving units that prominently showed the packages to potential consumers as a back drop to the cash register. There is now a complete ban on tobacco retail displays in the province of Ontario, including a complete ban on the use of these “power walls”.

Retail stores that sell tobacco products in those jurisdictions where such a display ban is in effect are required to have the tobacco products hidden from view. Thus, the traditional large displays of tobacco products (including the “power walls”) must now be completely covered from view of consumers. Not only do these jurisdictions prevent the display of all tobacco products, but they also prohibit customers from even touching them before they are paid for.

Moreover, in many jurisdictions, the regulations prevent retail store owners from putting the tobacco products behind “garage-style” or cupboard doors that open to display the entire inventory of tobacco products. Rather, retail store owners have to conceal the tobacco products in drawers underneath the counter, or behind a series of opaque wall coverings that can flip up when a customer requests a product. For example, the regulations in Ontario require that the wall coverings have a top-hinge “flip up” cover that closes automatically or immediately by gravity and these coverings cannot be larger than one foot in height by 2 feet in length and must open only one at a time. Wall coverings that cover the shelves with a bottom hinge “flip down” cover are not preferred because they do not close automatically and would remain open unless lifted back into a closed position.

There, therefore, is a need to provide a modular hinged door system that may be attached to an existing display unit and adapted to hide and conceal the contents stored on the unit, and that complies with the vast majority of regulations banning the display of tobacco products.

### SUMMARY OF THE INVENTION

According to one aspect of the invention there is provided a magnetically held hinged door for a display unit, comprising:
(a) a top extruded component comprising:
   i) a flange portion having one or more attachment means for removably attaching the hinged door system to a part of the display unit,
   ii) a retaining portion comprising an inverted U-shaped channel and a plurality of gripping tabs disposed in the inverted U-shaped channel, and
   iii) a flexible hinge interconnecting the flange portion and the retaining portion, and
(b) a panel having an upper end adapted to be removably retained within the inverted U-shaped channel,

wherein the hinged door swings about the flexible hinge between a first closed position and a second open position.

In a further aspect, there is provided a hinged door system for attachment to a display unit comprising:
(a) a flange portion having one or more attachment means for removably attaching the hinged door system to a part of the display unit,
(b) a flexible hinge extending from the flange portion, and
(c) a panel portion attached to the flexible hinge and capable of swinging about the flexible hinge between a first closed position and a second open position.

In further aspects of the present invention, there is provided a modular hinged door system for attachment to a display unit and a kit useful as a hinged door system for attachment to a display unit.

Numerous other objectives, advantages and features of the process will also become apparent to the person skilled in the art upon reading the detailed description of the preferred embodiments, and the claims.

### BRIEF DESCRIPTION OF THE DRAWINGS

The preferred embodiments of the present invention will be described with reference to the accompanying drawings in which like numerals refer to the same parts in the several views and in which:

FIG. 1 is a perspective partial view of a display unit covered by a preferred embodiment of the hinged door system of the present invention;

FIG. 2 is a cross-sectional view taken along line 2-2 of the preferred embodiment of the hinged door system of FIG. 1;

FIG. 3 is a partial cross-sectional view of a second preferred embodiment of the hinged door system of the present invention; and

FIG. 4 and FIG. 5 are partial cross-sectional views of other embodiments of the hinged door system of the present invention.

### DETAILED DESCRIPTION OF THE PREFERRED EMBODIMENTS

The preferred embodiments of the present invention will now be described with reference to the accompanying figures.

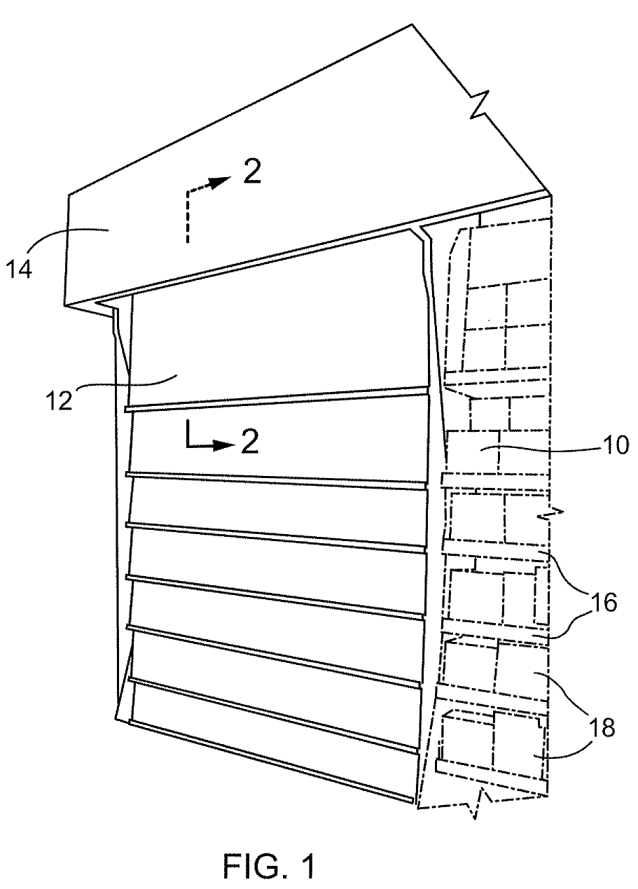

FIG. 1 is a perspective partial view of a typical display unit 10 covered by a preferred embodiment of the hinged door system 12 of the present invention. The display unit 10 is illustrated in FIG. 1 in stippled lines because the display unit 10 is covered and hidden by the door system 12. In this particular embodiment, the display unit 10 includes an overhead panel 14 (which is not hidden behind the door system 12) and a number of shelves 16 that are also illustrated in FIG. 1 with stippled lines. On the shelves 16 are stored various products 18 for sale, also illustrated in stippled lines.

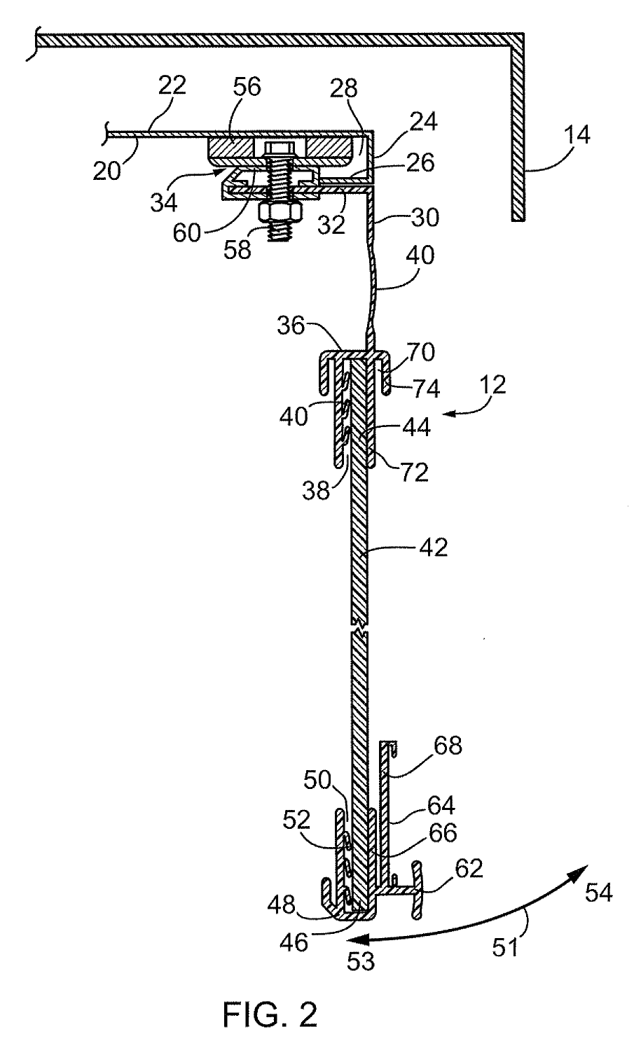

FIG. 2 is a cross-sectional view taken along line 2-2 of the door system 12 of FIG. 1. The overhead panel 14 is part of the display unit 10 and not a part of the door system 12. Also a part of the display unit 10 is a shelf 20 comprising a horizontal surface 22, a front vertical face 24 and flange 26, that define a C-shaped channel 28. In respect to the preferred embodiment of the door system 12 shown in FIG. 2, the shelf 20 and its components 22, 24 and 26, are all metallic so that a magnet may attach to the shelf 20.

The door system 12 includes a top plastic extruded component 30 that comprises a flange portion 32 of which are disposed one or more attachment means 34 for removably attaching the door system 12 to a part of the display unit 10, in this case the shelf 20. The top plastic extruded component 30 also includes a retaining portion 36 comprising an inverted U-shaped channel 38 and a plurality of gripping tabs 40 disposed in the inverted U-shaped channel 38. The top plastic extruded component 30 also includes a flexible hinge 40 interconnecting the flange portion 32 and the retaining portion 36. The flexible hinge 40 is preferably integrally extruded with the flange portion 32 and the retaining portion 36 and is flexible to allow movement of the retaining portion 36 relative to the flange portion 32.

The door system 12 further comprises a panel 42 having an upper end 44 adapted to be removably retained within the inverted U-shaped channel 38 by gripping tabs 40 biasing against the upper end 44, and a lower edge 46. The panel 42 is adapted to be cut to a size whereby the door system 12 covers a shelf space of the display unit 10. That is, the panel 42 is sized in terms of its height (the total distance from the upper end 44 to the lower end 46) to completely cover the shelf space of the display unit 10.

In a further embodiment (not illustrated), the hinged door system 12 comprises the flange portion 32 having one or more attachment means 34 for removably attaching the hinged door system 12 to a part of the display unit 10. The flexible hinge 40 extends from the flange portion 32. Attached to the flexible hinge 40 is the panel 42, thereby omitting the retaining portion 36 and its components (the inverted U-shaped channel 38 and the gripping tabs 40 disposed in the inverted U-shaped channel 38). The panel 40 is capable of swinging about the flexible hinge 40 between a first closed position 53 and a second open position 54.

The door system 12 further comprises a bottom plastic extruded component 48 having a U-shaped channel 50 and a plurality of gripping tabs 52 disposed in the U-shaped channel 50. The lower edge 46 of the panel 42 is adapted to be removably retained within the U-shaped channel 50 by tabs 52 biasing against lower end 46.

When removably attached to the shelf 20 of the display unit 10, the retaining portion 36, panel 42 and bottom plastic extruded component 48 swing about the flexible hinge 40 along arrow 51 between a first closed position 53 where the shelf space is hidden and concealed and a second open position 54.

The attachment means 34 of the door system 12 of FIG. 2 include magnets 56 adapted to removably attach the door system 12 to the metal shelf 20 and anyone of the components of the shelf 20, namely the horizontal surface 22, the front vertical face 24 and/or the flange 26. As shown in FIG. 2, the attachment means 34 also include a nut and bolt combination 58 that hold the magnets 56 on the flange portion 32. Optionally, the attachment means 34 may also include a spacer 60 disposed between the magnets 56 and the flange portion 32.

The spacer 60 is sized such that the magnets 56 can fit within the C-shaped channel 28. The attachment means 34, in particular the spacer 60, and the flange portion 32 are adapted and sized to position the magnets 56 properly within the C-shaped channel 28 so that when the door system 12 is assembled and installed on the display unit 10, the retaining portion 36, panel 42 and bottom plastic extruded component 48 can swing about the flexible hinge 40 along arrow 51 and clear all parts of the display unit 10, including the shelf 20 and its components 22, 24 and 26. As will be appreciated, the shape and size of the spacer 60 and the flange portion 32 may be changed depending on the particular configuration of the shelf 20 and its components 22, 24 and 26.

The bottom plastic extruded component 48 also preferably includes a handle 62 that can be used to grasp and cause the retaining portion 36, panel 42 and bottom plastic extruded component 48 to swing about the flexible hinge 40 to the second open position 54. Also, the bottom plastic extruded component 48 may include a slot 64 defined by upstanding flange 66 and wall 68. The slot 64 is adapted to receive and releasably retain a bottom edge of a sheet containing printed matter, such as advertising material, pricing etc. The slot 64 is in general alignment with cooperating slot 70 defined by wall 72 and downward flanges 74 on the retaining portion 36. The cooperating slot 64 is adapted to receive and releasably retain a top edge of the sheet containing printed matter.

In the preferred embodiment of the door system 12 shown in FIG. 2, the top plastic extruded component 30, the panel 42, the bottom plastic extruded component 48 and the attachment means 34 are provided as separate parts, making the door system 12 a modular system that allows the door system 12 to be adapted and sized to fit varying sizes of display units 10 and shelf spaces. For example, as mentioned above, the panel 42 may be cut to a desired size in terms of its height (the total distance from the upper edge 44 to the lower end 46) to completely cover the shelf space of the display unit 10. Should the display unit 10 have shelf spaces of different sizes, then the door system can be adapted to fit each differently size space. The bottom plastic extruded component 48 is an optional part, but it is preferred since it provides stability and additional features such as the handle 62 and slot 64. The modular door system 12 may also be provided as a kit that includes instructions on how to assemble the door system 12 to fit differently size shelf spaces and removably attach it to a display unit 10.

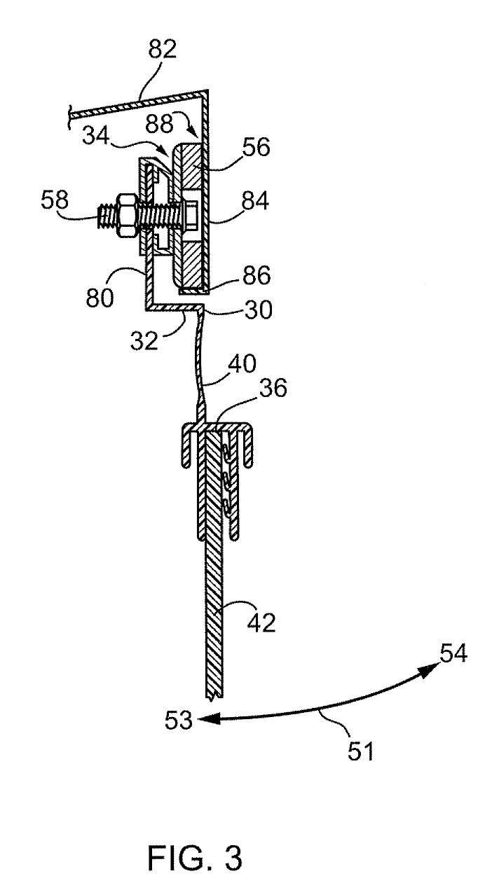

FIG. 3 is a partial cross-sectional view of a second preferred embodiment of the hinged door system 12 of the present invention. In this embodiment, the top plastic extruded component 30 also comprises a retaining portion 36 configured as in FIG. 2 to releasably retain the panel 42. The top plastic extruded component 30 further includes a flexible hinge 40 interconnecting the flange portion 32 and the retaining portion 36. The flange portion 32 includes a vertically disposed end 80 on which the attachment means 34 is disposed. In this embodiment, the shelf 82 is metal and includes a vertical face 84 and a flanged end 86 that define a C-shaped space 88. The attachment means 34 are the same as shown in FIG. 2 and include magnets 56, nut and bolt combination 58 and spacer 60 disposed between the magnets 56 and the vertically disposed end 80. The spacer 60 is sized such that the magnets 56 can fit within the C-shaped space 88.

As in the embodiment of FIG. 2, when attached to the display unit 10, the retaining portion 36, panel 42 and bottom plastic extruded component 48 (not shown in FIG. 3) swing about the flexible hinge 40 along arrow 51 between a first closed position 53 and a second open position 54. The attachment means 34, including spacer 60, and the flange portion 32 are sized and configured such that the retaining portion 36, panel 42 and bottom plastic extruded component 48 can swing clear of all parts of the display unit 10, including shelf 82 and its parts 84 and 96.

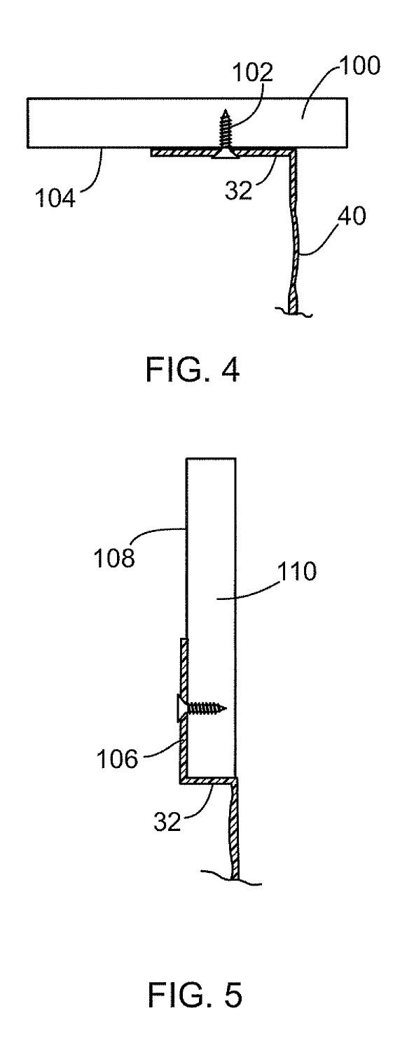

In FIG. 4 and FIG. 5, alternative embodiments of the door system 12 are illustrated where the door system 12 may be attached to a display unit that does not have metal shelves or parts. In embodiment of FIG. 4, the flange portion 32 is adapted to fit under a horizontal non-metal shelf 100, such as a wooden shelf. The attachment means comprise a wood screw 102 that is driven through a part of the flange portion 32 and into the bottom surface 104 of the shelf 100. In the embodiment of FIG. 5, the flange portion 32 includes a vertically disposed end 106 adapted to fit against a vertical surface 108 of a non-metallic part 110, such as a wooden part, of the display unit 10. The attachment means for this embodiment also comprises a wood screw 112 that is driven through a part of the vertically disposed end 106 and into the vertical surface 108 of the part 110.

Although the present invention has been shown and described with respect to its preferred embodiments and in the examples, it will be understood by those skilled in the art that other changes, modifications, additions and omissions may be made without departing from the substance and the scope of the present invention as defined by the attached claims.

What is claimed is:

1. A magnetically held hinged door for a display unit, comprising:
(a) a top plastic extruded component comprising:
i) a flange portion having one or more magnets adapted to removably attach the hinged door to metal shelves and other metal parts of the display unit,
ii) a retaining portion comprising an inverted U-shaped channel and a plurality of gripping tabs disposed in the inverted U-shaped channel, and
iii) a flexible hinge interconnecting the flange portion and the retaining portion, and
(b) a panel having an upper end adapted to be removably retained within the inverted U-shaped channel,
wherein the magnetically held hinged door swings about the flexible hinge between a first closed position and a second open position.

2. The magnetically held hinged door of claim 1 further comprising a bottom plastic extruded component comprising a U-shaped channel and a plurality of gripping tabs disposed in the U-shaped channel, wherein a lower end of the panel is removably retained within the U-shaped channel.

3. The magnetically held hinged door of claim 1 wherein the panel is adapted to be cut to a size whereby the magnetically held hinged door covers a shelf space of the display unit when the hinged door is in the closed position.

4. The magnetically held hinged door of claim 2 wherein the bottom plastic extruded component comprises a handle.

5. The magnetically held hinged door of claim 2 wherein the bottom plastic extruded component comprises a slot adapted to receive and releasably retain a bottom edge of a sheet containing printed matter.

6. The magnetically held hinged door of claim 5 wherein the top plastic extruded component comprises a slot adapted to receive and releasably retain a top edge of the sheet.

7. The magnetically held hinged door of claim 1 wherein the each of the magnets is fastened to the flange portion with a nut and a bolt.

8. The magnetically held hinged door of claim 7 further comprising a clip disposed between the flange portion and the magnet.

9. A modular hinged door system for attachment to a display unit, comprising:
(a) a top plastic extruded component comprising:
i) a flange portion having one or more attachment means for removably attaching the hinged door system to a part of the display unit,
ii) a retaining portion comprising an inverted U-shaped channel and a plurality of gripping tabs disposed in the inverted U-shaped channel, and
iii) a flexible hinge interconnecting the flange portion and the retaining portion, and
(b) a panel having an upper end adapted to be removably retained within the inverted U-shaped channel,
wherein the hinged door swings about the flexible hinge between a first closed position and a second open position.

10. The modular hinged door system of claim 9 further comprising a bottom plastic extruded component comprising a U-shaped channel and a plurality of gripping tabs disposed in the U-shaped channel, wherein a lower end of the panel is adapted to be removably retained within the U-shaped channel.

11. The modular hinged door system of claim 9 wherein the panel is adapted to be cut to a size whereby the hinged door system covers a shelf space of the display unit when the hinged door is in the closed position.

12. The modular hinged door system of claim 9 wherein the attachment means are magnets adapted to removably attach the hinged door to metal shelves and other metal parts of the display unit.

13. The modular hinged door system of claim 9 wherein the attachment means are screws adapted to removably attach the hinged door to shelves and other parts of the display unit.

14. The modular hinged door system of claim 10 wherein the bottom plastic extruded component comprises a handle.

15. The modular hinged door system of claim 10 wherein the bottom plastic extruded component comprises a slot adapted to receive and releasably retain a bottom edge of a sheet containing printed matter.

16. The modular hinged door system of claim 15 wherein the top plastic extruded component comprises a slot adapted to receive and releasably retain a top edge of the sheet.

17. The modular hinged door system of claim 12 wherein the each of the magnets is fastened to the flange portion with a nut and a bolt.

18. A kit useful as a hinged door system for attachment to a display unit, the kit comprising:
(a) a top plastic extruded component comprising:
i) a flange portion having one or more attachment means for removably attaching the hinged door system to a part of the display unit,
ii) a retaining portion comprising an inverted U-shaped channel and a plurality of gripping tabs disposed in the inverted U-shaped channel, and
iii) a flexible hinge interconnecting the flange portion and the retaining portion, and
(b) a panel having an upper end adapted to be removably retained within the inverted U-shaped channel
wherein when the kit is assembled and is attached to the display unit, the hinged door swings about the flexible hinge between a first closed position and a second open position.

19. The kit of claim 18 further comprising a bottom plastic extruded component comprising a U-shaped channel and a plurality of gripping tabs disposed in the U-shaped channel, wherein a lower end of the panel is adapted to be removably retained within the U-shaped channel.

20. The kit of claim 18 wherein the panel is adapted to be cut to a size whereby the hinged door system covers a shelf space of the display unit when the hinged door is in the closed position.

21. The kit of claim 18 wherein the attachment means are magnets adapted to removably attach the hinged door to metal shelves and other metal parts of the display unit.

22. The kit of claim 18 wherein the attachment means are screws adapted to removably attach the hinged door to shelves and other parts of the display unit.

23. The kit of claim 19 wherein the bottom plastic extruded component comprises a handle.

24. The kit of claim 19 wherein the bottom plastic extruded component comprises a slot adapted to receive and releasably retain a bottom edge of a sheet containing printed matter.

25. The kit of claim 24 wherein the top plastic extruded component comprises a slot adapted to receive and releasably retain a top edge of the sheet.

26. The kit of claim 21 wherein the each of the magnets is fastened to the flange portion with a nut and a bolt.

27. The kit of claim 18 further comprising instructions on how to assemble the hinged door system and removably attach it to a display unit.

28. A hinged door system for attachment to a display unit comprising:
(a) a flange portion having one or more attachment means for removably attaching the hinged door system to a part of the display unit,
(b) a flexible hinge extending from the flange portion, and
(c) a panel portion attached to the flexible hinge and capable of swinging about the flexible hinge between a first closed position and a second open position.

29. The hinged door system of claim 28 wherein the panel is adapted to be cut to a size whereby the hinged door system covers a shelf space of the display unit when the hinged door is in the closed position.

30. The hinged door system of claim 28 wherein the attachment means are magnets adapted to removably attach the hinged door to metal shelves and other metal parts of the display unit.
